(19) United States
(12) Patent Application Publication
(10) Pub. No.: US 2014/0042329 A1
(43) Pub. Date: Feb. 13, 2014

(54) RADIOGRAPHIC APPARATUS AND RADIOGRAPHIC SYSTEM

(71) Applicant: CANON KABUSHIKI KAISHA, Tokyo (JP)

(72) Inventors: Hideyuki Okada, Honjo-shi (JP); Toshio Kameshima, Kumagaya-shi (JP); Tomoyuki Yagi, Honjo-shi (JP); Katsuro Takenaka, Honjo-shi (JP); Sho Sato, Saitama-shi (JP); Atsushi Iwashita, Honjo-shi (JP); Eriko Sugawara, Honjo-shi (JP)

(73) Assignee: CANON KABUSHIKI KAISHA, Tokyo (JP)

(21) Appl. No.: 13/959,470

(22) Filed: Aug. 5, 2013

(30) Foreign Application Priority Data
Aug. 9, 2012 (JP) 2012-177444

(51) Int. Cl. G01T 1/20

(52) U.S. Cl. CPC G01T 1/2006
USPC 250/366

(57) ABSTRACT

A radiographic apparatus includes a scintillator configured to convert radiation into first light, a photoelectric conversion unit including a plurality of photoelectric conversion elements each configured to convert the first light into an electrical signal, and a light detection unit configured to detect the first light. In such a radiographic apparatus, the photoelectric conversion unit and the light detection unit are arranged to sandwich the scintillator therebetween, and the light detection unit includes a light guide plate, a photodetector arranged on a side face of the light guide plate, and a light reflection section arranged to reflect the first light toward the photodetector.

### BACKGROUND OF THE INVENTION

1. Field of the Invention

The present invention relates to radiographic apparatuses and radiographic systems.

2. Description of the Related Art

Recently, practical implementation of a radiographic apparatus that includes a flat panel type detector (FPD) formed of a semiconductor material has been in progress as a radiographic apparatus used in medical imaging diagnosis and non-destructive test using radiation such as X-rays. FPDs to be used in such a radiographic apparatus are broadly classified into a direct conversion type and an indirect conversion type. A radiographic apparatus of an indirect conversion type includes an FPD that includes a photoelectric conversion unit and a wavelength conversion element. The photoelectric conversion unit includes a plurality of pixels that each includes a photoelectric conversion element for converting light into an electrical signal, and the plurality of pixels is arranged in a two-dimensional array on a substrate. The wavelength conversion element converts the radiation into light of a wavelength band range which the photoelectric conversion element can sense. A semiconductor material such as a-Si is used for the photoelectric conversion elements, and a scintillator is used as the wavelength conversion element.

At the time of imaging, the radiographic apparatus carries out imaging in synchronization with a radiation generation device. As a synchronization method, the radiographic apparatus can be synchronized with the radiation generation device by detecting X-rays radiated from the X-ray generation unit. In such a case, providing X-ray detectors in and out of the radiographic apparatus is known, and this has advantages in that man-hour of connection work is not necessary and that the radiographic apparatus can be moved around and used in combination with various X-ray generation units.

According to techniques discussed in Japanese Patent Application Laid-Open No. 2001-311778 and Japanese Patent Application Laid-Open No. 2007-147370, a light detection unit configured to detect light that is obtained by converting radiation by a scintillator is provided in a radiographic apparatus to detect irradiation of the radiation. The configuration discussed in Japanese Patent Application Laid-Open No. 2001-311778 further includes a light detection unit arranged on the photoelectric conversion unit at a face opposed to a face facing the scintillator in the FPD. The light detection unit includes a light detection circuit and an optical waveguide configured to converge visible light that has been converted by the scintillator and has passed through the photoelectric conversion unit onto the light detection circuit to detect irradiation of the radiation. Meanwhile, in the configuration discussed in Japanese Patent Application Laid-Open No. 2007-147370, the light detection unit includes a light guide plate, a light reflection section, and a light detection circuit, and visible light that has been converted by the scintillator and has passed through the photoelectric conversion unit is converged onto the light detection circuit through the light guide plate and the light reflection section to detect irradiation of the X-rays.

In each of the configurations discussed in Japanese Patent Application Laid-Open No. 2001-311778 and Japanese Patent Application Laid-Open No. 2007-147370, light obtained by converting the radiation by the scintillator is transmitted through the photoelectric conversion unit and obtained by the light detection unit. The photoelectric conversion unit is formed of a semiconductor material or a metal material, and thus the light converted by the scintillator has its light amount reduced as the light passes through the photoelectric conversion unit. Therefore, if the weak radiation is irradiated, irradiation of the radiation may not be detected. Further, if a change in dosage at the beginning of the irradiation of the radiation is gradual, there may be a delay in detecting the irradiation of the radiation. In other words, an issue lies in detection accuracy in detecting irradiation of radiation.

### SUMMARY OF THE INVENTION

The present invention is directed to providing a radiographic apparatus and a radiographic system capable of detecting irradiation of radiation with high accuracy.

According to an aspect of the present invention, a radiographic apparatus includes a scintillator configured to convert radiation into first light, a photoelectric conversion unit including a plurality of photoelectric conversion elements each configured to convert the first light into an electrical signal, and a light detection unit configured to detect the first light. In such a radiographic apparatus, the photoelectric conversion unit and the light detection unit are arranged to sandwich the scintillator therebetween.

Further features and aspects of the present invention will become apparent from the following description of exemplary embodiments with reference to the attached drawings.

### BRIEF DESCRIPTION OF THE DRAWINGS

FIG. 1 is a sectional view schematically illustrating a radiographic apparatus according to a first exemplary embodiment.

FIG. 2 is an enlarged sectional view illustrating the radiographic apparatus according to the first exemplary embodiment.

FIGS. 3A and 3B are plan views each illustrating the radiographic apparatus according to the first exemplary embodiment.

FIG. 4 is an equivalent circuit diagram of the radiographic apparatus according to the first exemplary embodiment.

FIG. 5 is a timing chart of the radiographic apparatus according to the first exemplary embodiment.

FIG. 6 is a sectional view schematically illustrating a radiographic apparatus according to a second exemplary embodiment.

FIG. 7 is an enlarged sectional view illustrating the radiographic apparatus according to the second exemplary embodiment.

FIG. 8 is another enlarged sectional view illustrating the radiographic apparatus according to the second exemplary embodiment.

FIG. 9 is a sectional view schematically illustrating a radiographic apparatus according to a third exemplary embodiment.

FIG. 10 is a sectional view illustrating a photoelectric conversion element according to a fourth exemplary embodiment.

FIG. 11 is a schematic diagram illustrating a radiographic system according to a fifth exemplary embodiment.

### DESCRIPTION OF THE EMBODIMENTS

Hereinafter, a first exemplary embodiment will be described.

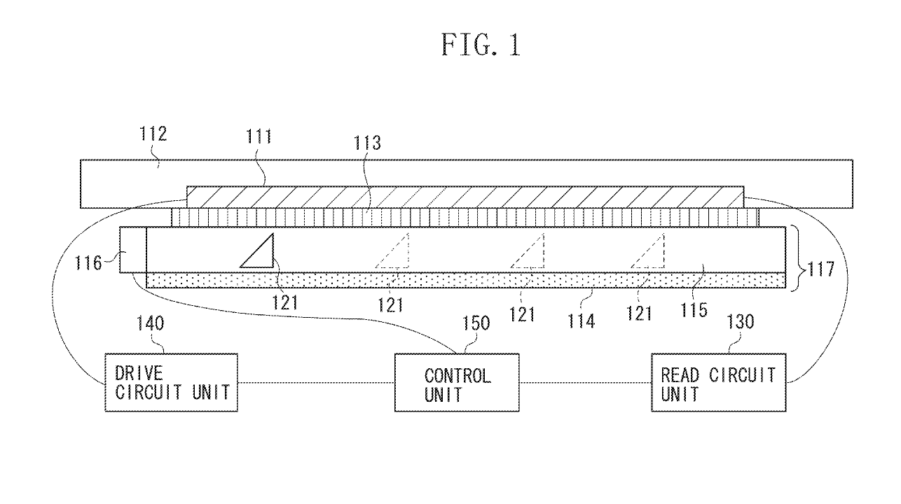

FIG. 1 is a sectional view schematically illustrating an exemplary configuration of a radiographic apparatus according to the first exemplary embodiment. The radiographic apparatus of the first exemplary embodiment includes a photoelectric conversion unit 111, a substrate 112, a scintillator 113, a light detection unit 117, a read circuit unit 130, and a drive circuit unit 140. The read circuit unit 130 reads out electrical signals from the photoelectric conversion unit 111, and the drive circuit unit 140 drives the photoelectric conversion unit 111.

The radiographic apparatus further includes a control unit 150 configured to control the light detection unit 117, the read circuit unit 130, and the drive circuit unit 140. The photoelectric conversion unit 111 is an area on the insulating substrate 112 and includes pixels that each include a photoelectric conversion element configured to convert light into an electrical signal, and the stated pixels are arranged in a two-dimensional array. Each pixel, for example, includes a thin film transistor (TFT) serving as a switching element connected to a drive wiring and to a signal line and a photoelectric conversion element connected to the TFT. The substrate 112, for example, is an insulating substrate formed of glass or the like. The scintillator 113 converts radiation such as X-rays that have entered the radiographic apparatus into light of a wavelength band range which the photoelectric conversion element can sense.

In the exemplary embodiments of the present invention, first light corresponds to light that is obtained by converting radiation by the scintillator 113 and can be sensed by a photoelectric conversion element. The scintillator 113 is arranged on the photoelectric conversion unit 111, and may be desirably arranged on a side of the photoelectric conversion unit 111 where the photoelectric conversion elements are arranged. The scintillator 113 may be implemented by affixing a carbon or a film on which the scintillator 113 is deposited onto the photoelectric conversion unit 111 or by directly depositing the scintillator 113 onto the photoelectric conversion unit 111.

The light detection unit 117 is arranged on a face of the scintillator 113 opposed to the face facing the photoelectric conversion unit 111 and includes a light guide plate 115, a light absorption layer 114, a photodetector 116, and a plurality of light reflection sections 121. That is, the photoelectric conversion unit 111 and the light detection unit 117 are arranged to sandwich the scintillator 113 therebetween. The light guide plate 115 includes a first face facing the scintillator 113, a second face that is opposed to the first face, and a plurality of side faces. The light guide plate 115 is desirably formed of a highly transparent resin material with high light propagation efficiency such as acrylic resin.

The light absorption layer 114 is arranged on the second face of the light guide plate 115, opposed to the first face facing the scintillator 113. That is, the light absorption layer 114 and the scintillator 113 are arranged to sandwich the light guide plate 115 therebetween. The photodetector 116 is arranged on the side face of the light guide plate 115. The light reflection sections 121 are arranged inside the light guide plate 115 and are each positioned to reflect light converted by the scintillator 113 in the direction of the photodetector 116. The control unit 150 is communicably connected to the photodetector 116, the read circuit unit 130, and the drive circuit unit 140, and the read circuit unit 130 and the drive circuit unit 140 are connected to the photoelectric conversion unit 111.

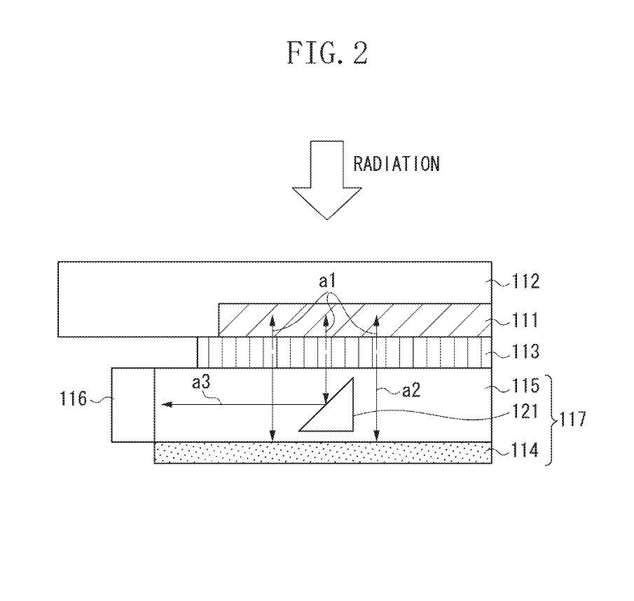

FIG. 2 is an enlarged sectional view illustrating an exemplary configuration of the radiographic apparatus according to the first exemplary embodiment and illustrates a state in which radiation has passed through the substrate 112 and the photoelectric conversion unit 111 and is incident on the scintillator 113 in the configuration illustrated in FIG. 1. In other words, the photoelectric conversion unit 111 is arranged between the scintillator 113 and a radiation generation device (not illustrated) in FIG. 1. Radiation that enters the radiographic apparatus passes through the substrate 112 and the photoelectric conversion unit 111 and then is converted into first light by the scintillator 113. The resulting first light is emitted from the scintillator 113 in the direction of the photoelectric conversion unit 111 (i.e., direction of a1 in FIG. 2) and in the direction of the light detection unit 117 (i.e., direction of a2 in FIG. 2).

Visible light emitted in the direction of a1 is converted into electrical signals according to an intensity of the light by the photoelectric conversion unit 111, and the electrical signals are accumulated in the form of images. Visible light emitted in the direction of a2 is incident on the light reflection section 121 or the light absorption layer 114. Visible light that is incident on the light reflection section 121 is reflected thereby in a direction of a3 and then is incident on the photodetector 116. Here, a light receiving element such as a photodiode can be used for the photodetector 116. Visible light that is incident on the light absorption layer 114 is absorbed by the light absorption layer 114 and dissipates.

If the light absorption layer 114 is not provided, the first light emitted in the direction of a2 is reflected at a position corresponding to the light absorption layer 114 in accordance due to difference in the refractive index or the like. Then, the reflected light passes through the scintillator 113 and returns to the photoelectric conversion unit 111, and thus a light amount incident on the photoelectric conversion elements increases. Of the visible light emitted in the direction of a2, the visible light that is incident on the light reflection section 121 is not reflected back to the photoelectric conversion unit 111. That is, the light amount differs between a location where the light reflection section 121 is present and a location where the light reflection section 121 is not present, and thus that difference in the light amount appears as an artifact in an image.

The light absorption layer 114 is provided to suppress such an artifact. If the radiation enters the radiographic apparatus from the side of the substrate 112, part of the radiation is absorbed by the substrate 112, and thus the amount of the radiation to be incident on the scintillator 113 decreases. Thus, the substrate 112 is desirably formed of a material that is less absorptive of the radiation. If a material that absorbs the radiation to a certain degree such as glass is to be used, for example, the material is desirably formed into a thin substrate to reduce the amount of absorption to a desired level or less.

According to the first exemplary embodiment, the light detection unit 117 can detect the first light converted by the scintillator 113 without having the first light passing through the photoelectric conversion unit 111. Therefore, the first light that has been converted by the scintillator 113 enters the light detection unit 117 without having its light amount being reduced by the photoelectric conversion unit 111. Accordingly, light detection efficiency of the light detection unit 117 improves.

In the example described thus far, the radiation passes through the substrate 112 and is then incident on the scintillator 113. However, another configuration in which radiation passes through the light detection unit 117 and is then incident on the scintillator 113 can yield a similar effect. That is because the first light that has been converted by the scintillator 113 enters the light detection unit 117 without having its light amount being reduced by the photoelectric conversion unit 111. In other words, such a case corresponds to a configuration in which the scintillator 113 is arranged between the photoelectric conversion unit 111 and a radiation generation device (not illustrated) and the light detection unit 117 is arranged between the scintillator 113 and the radiation generation device (not illustrated).

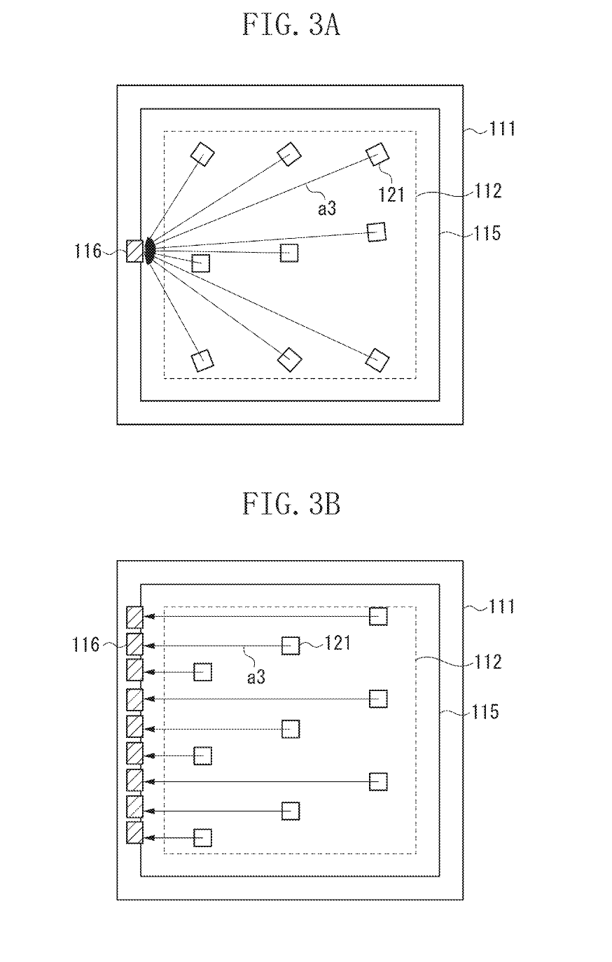

FIGS. 3A and 3B are plan views each illustrating an exemplary arrangement of the light reflection sections 121 within the light guide plate 115 of the radiographic apparatus according to the first exemplary embodiment. The light guide plate 115 illustrated in FIG. 3A includes nine light reflection sections 121. The nine light reflection sections 121 are arranged such that each of the light reflection sections 121 reflects the first light that has been converted by the scintillator 113 toward the single photodetector 116 arranged on a side face of the light guide plate 115 and such that reflected light from one light reflection section 121 does not interfere with reflected light from another light reflection section 121. Such an arrangement allows the first light that has been converted by the scintillator 113 to be detected by the photodetector 116.

The light guide plate 115 illustrated in FIG. 3B also includes nine light reflection sections 121. The nine light reflection sections 121 are arranged such that each of the light reflection sections 121 reflects the first light that has been converted by the scintillator 113 toward a corresponding one of the nine photodetectors 116 arranged on a side face of the light guide plate 115 and such that reflected light from one light reflection section 121 does not interfere with reflected light from another light reflection section 121. Such a disposition allows the first light that has been converted by the scintillator 113 to be detected by the photodetectors 116.

Then, based on the intensity of light detected by each of the photodetectors 116, an intensity distribution of light that has passed through the body of a subject can be obtained according to the transmittance of the light, or a dose of the radiation on a specified location of the radiographic apparatus can be measured. Detecting the measurement of the radiation on the specified location enables auto exposure control (AEC) for stopping irradiation of the radiation at a point in time at which an exposure amount reaches an appropriate amount for imaging.

The light reflection sections 121 are desirably arranged evenly within the light guide plate 115 because the X-rays pass through the subject body and then enters the radiographic apparatus having an intensity distribution according to the transmittance of the X-rays through the subject body. If there are limitations in terms of the number of the light reflection sections 121 that can be arranged, the light reflection sections 121 are desirably arranged at the center of the light guide plate 115, which is likely to correspond to a site of interests of the subject, and at four corners of the light guide plate 115, which are likely to correspond to sites where the subject is not located and are thus more likely to be irradiated with the radiation intensely.

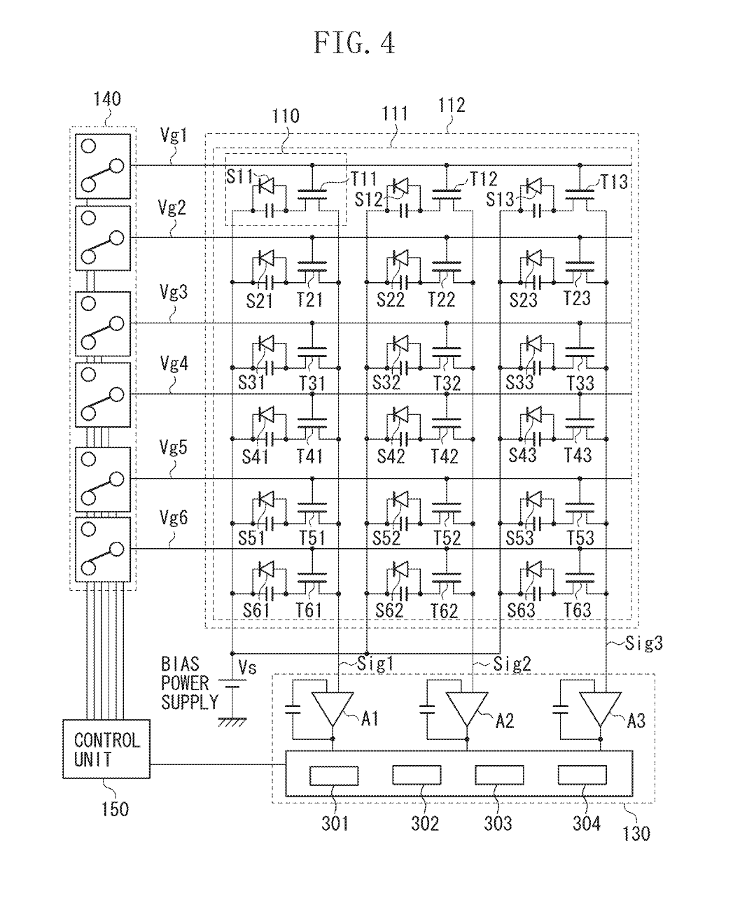

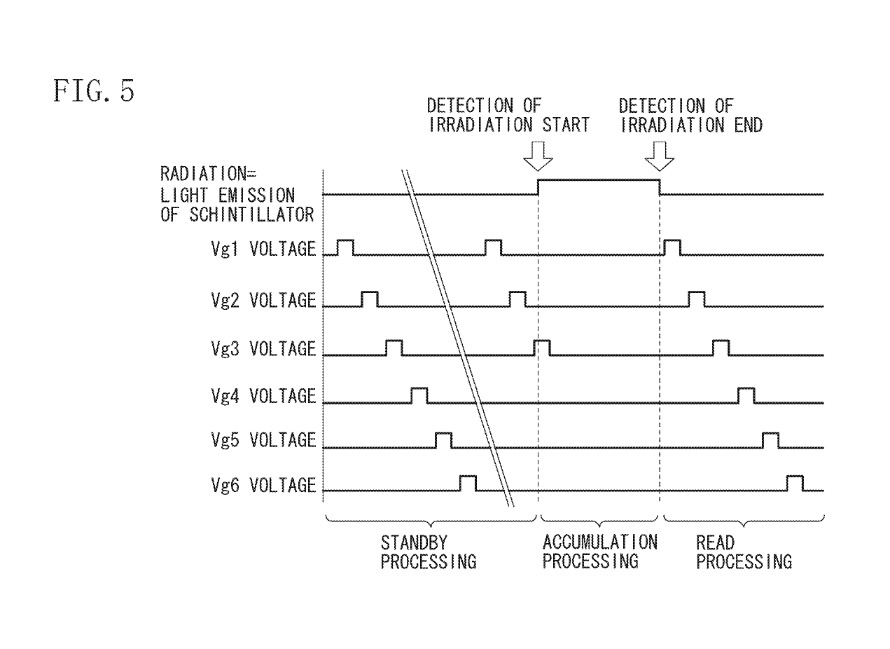

Subsequently, a method for controlling the radiographic apparatus by the control unit 150 will be described with reference to FIGS. 4 and 5. FIG. 4 is an equivalent circuit diagram of the radiographic apparatus according to the first exemplary embodiment, and FIG. 5 is a timing chart for describing operations of the radiographic apparatus.

As illustrated in FIG. 4, the radiographic apparatus includes the photoelectric conversion unit 111, the drive circuit unit 140, the read circuit unit 130, a bias power supply for supplying a bias voltage Vs, and the control unit 150. The photoelectric conversion unit 111 includes a plurality of pixels 110 that are arranged in a two-dimensional matrix form on the substrate 112. Each of the plurality of pixels 110 includes a photoelectric conversion element S and a switching element T. Although only eighteen pixels 110 that are arranged in a 6 rows by 3 columns matrix are indicated in the photoelectric conversion unit 111 illustrated in FIG. 4, a greater number of pixels 110 may be arranged in a two-dimensional matrix form. Photoelectric conversion elements S11 to S63 each convert incident light into an electric charge.

Switching elements T11 to T63 transfer electrical signals that are based on the electric charges converted by the respective photoelectric conversion elements S11 to S63 to the outside of the pixels 110. The switching elements T11 to T63 are, for example, each constituted by a TFT formed of a non-single crystalline semiconductor such as amorphous silicon. The bias voltage Vs is applied to one electrode of each of the photoelectric conversion elements S11 to S63 by the bias power supply. Drain electrodes of each of the switching elements T11 to T63 are connected to the other electrodes of each of the photoelectric conversion elements S11 to S63, respectively.

Source electrodes of each of the switching elements T11 to T63 is connected to a given one of signal wirings Sig1 to Sig3. The radiographic apparatus further includes drive wirings Vg1 to Vg6 that are aligned in a column direction, and each of the drive wirings Vg1 to Vg6 electrically connects gate electrodes of switching elements in a plurality of pixels 110 arranged in a row direction, for example, the gate electrodes of the switching elements T11 to T13. The drive wirings Vg1 to Vg6 are electrically connected to the drive circuit unit 140.

If the substrate 112 is an insulating substrate, the drive circuit unit 140 is mounted on one side of the substrate 112. The drive circuit unit 140 applies voltages to the respective switching elements T11 to T63 at a predetermined timing based on a control signal from the control unit 150. The read circuit unit 130 reads the electrical signals transferred from the respective switching elements T11 to T63 through the signal wirings Sig1 to Sig3. The read circuit unit 130 essentially includes preamplifiers A1 to A3 each serving as a first-stage amplifier, a sample-and-hold circuit 301, an analog multiplexer 302, a buffer amplifier 303, and an analog-to-digital (A/D) converter 304. In the read circuit unit 130, the signal wirings Sig1 to Sig3 are electrically connected to inputs of the preamplifiers A1 to A3, respectively.

FIG. 5 is a timing chart illustrating voltages of the respective drive wirings Vg1 to Vg6 (i.e. on or off voltage to allow the switching elements T11 to T63 to enter a conducting state or a non-conducting state) and irradiation of the radiation (i.e., light emission of the scintillator 113) in the radiographic apparatus illustrated in FIG. 4. The control unit 150 carries out standby processing to wait for the irradiation of the radiation.

In the standby processing, the control unit 150 controls the drive circuit unit 140 to repeatedly turn on or off the switching elements T11 to T63 on a row-by-row basis, and thus dark current components of the photoelectric conversion elements S11 to S63 are reset. The above operation is referred to as a “dummy read operation.”

Once radiation enters the radiographic apparatus, the radiation is converted into the first light by the scintillator 113, and the first light then enters the photodetector 116 of the light detection unit 117. Upon detecting the first light, the photodetector 116 determines that the irradiation of the radiation has started and outputs a detection signal of an irradiation start to the control unit 150. Upon receiving the detection signal of the irradiation start, the control unit 150 stops the “dummy read operation” of the standby processing and carries out accumulation processing for accumulating electric charges generated in the plurality of pixels 110. In the accumulation processing, the control unit 150 controls the drive circuit unit 140 to turn off the entire switching elements T11 to T63 and to accumulate the electric charges generated in the photoelectric conversion elements S11 to S63 into the pixels 110.

Then, once the irradiation of the radiation stops, the first light stops entering the photodetector 116 as well. Upon detecting an end of the irradiation of the first light, the photodetector 116 outputs a detection signal of an irradiation end to the control unit 150. Upon receiving the detection signal of the irradiation end, the control unit 150 transitions from the accumulation processing to read processing to read out the electrical signals from the pixels 110 and controls the drive circuit unit 140 to obtain a radiation image. In the read processing, the control unit 150 controls the drive circuit unit 140 to repeatedly turn on or off the switching elements T11 to T63 on a row-by-row basis. Then, the control unit 150 outputs the electrical signals that are based on the electric charges generated by the photoelectric conversion elements S11 to S63 to the read circuit unit 130 and obtains the radiation image.

By detecting the light from the scintillator 113 directly by the photodetector 116 in this manner, the light can be detected by the photodetector 116 without being attenuated by the photoelectric conversion unit 111. Accordingly, the radiographic apparatus can reliably detect even irradiation of weak radiation, and quickly moving onto the accumulation operation allows an amount of unwanted exposure of the subject that can be caused by a time lag in radiation detection to be reduced. Thus, an artifact on an image such as steps can be reduced.

A second exemplary embodiment will now be described.

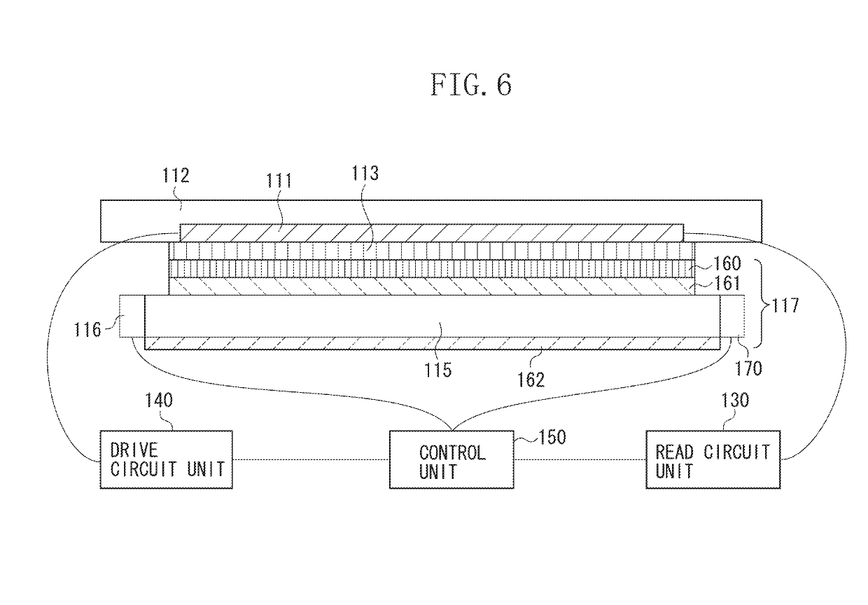

The configuration of a radiographic apparatus according to the second exemplary embodiment is similar to the configuration of the radiographic apparatus of the first exemplary embodiment illustrated in FIG. 1. FIG. 6 is a sectional view schematically illustrating an exemplary configuration of the radiographic apparatus according to the second exemplary embodiment. In FIG. 6, components that are identical to those illustrated in FIG. 1 are given identical reference numerals. The configuration illustrated in FIG. 6 differs from that illustrated in FIG. 1 in a connection between the light detection unit 117 and the control unit 150. Hereinafter, points in which the second exemplary embodiment differs from the first exemplary embodiment will be described.

The light detection unit 117 further includes a light reflection/transmission layer 160, a light diffusion layer 161, a light reflection layer 162, and a light generator 170. The light reflection/transmission layer 160, the light diffusion layer 161, the light guide plate 115, and the light reflection layer 162 are arranged in the stated order from a side on which the scintillator 113 is located. The light reflection/transmission layer 160 has a two-way mirror function in which its reflectance and transmittance are constant and uniform. The light reflection layer 162 is arranged on a face of the light guide plate 115 opposed to a face facing the light diffusion layer 161, and the photodetector 116 is arranged on a side face of the light guide plate 115. The light generator 170 is arranged on another side face of the light guide plate 115 opposed to a side face on which the photodetector 116 is arranged, and the light generator 170 is configured to emit second light that is distinct from the first light. The control unit 150 is communicably connected to the photodetector 116, the read circuit unit 130, the drive circuit unit 140, and the light generator 170, and the read circuit unit 130 and the drive circuit unit 140 are connected to the photoelectric conversion unit 111.

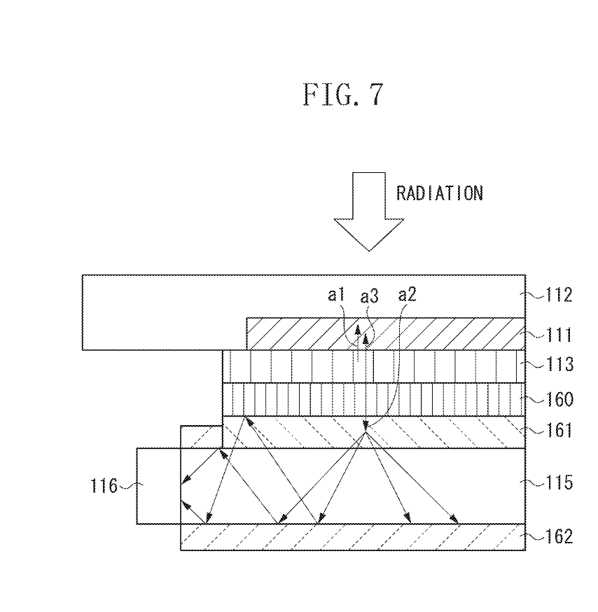

FIG. 7 is an enlarged sectional view illustrating an exemplary configuration of the radiographic apparatus according to the second exemplary embodiment of the present invention and illustrates a state in which radiation has passed through the substrate 112 in the configuration illustrated in FIG. 6. Radiation that enters the radiographic apparatus passes through the substrate 112 and the photoelectric conversion unit 111 and is then converted into the first light by the scintillator 113. Then, the first light is incident in the direction of the photoelectric conversion unit 111 (i.e., direction of a1 in FIG. 7) and in the direction of the light reflection/transmission layer 160. The first light in the direction of a1 is converted into electrical signals in the photoelectric conversion unit 111 according to an intensity of the light, and the electrical signals are accumulated in the form of images. Meanwhile, the first light incident in the direction of the light reflection/transmission layer 160 is split into first light traveling in a direction of a3 and first light traveling in a direction a2 as illustrated in FIG. 7 according to the reflectance and the transmittance of the light reflection/transmission layer 160.

The first light traveling in the direction of a3 is accumulated in the photoelectric conversion unit 111, similarly to the first light traveling in the direction of a1. Meanwhile, the first light traveling in the direction of a2 is diffused by the light diffusion layer 161 and then enters the light guide plate 115. Then, that first light undergoes repeated cycles of reflection by the light reflection layer 162 and the light reflection/transmission layer 160 and diffusion by the light diffusion layer 161 while traveling inside the light guide plate 115 and enters the photodetector 116. Here, the transmittance of the light reflection/transmission layer 160 may be set higher than the transmittance of the photoelectric conversion unit 111, and thus the light amount to be detected by the photodetector 116 can be increased. In addition, depending on the transmittance of the light reflection/transmission layer 160, part of the light that is diffusely reflected within the light guide plate 115 returns to the photoelectric conversion unit 111. Therefore, the diffusion coefficient and the transmittance of the light diffusion layer 161 are desirably adjusted to levels that do not generate a sense of incongruity in images.

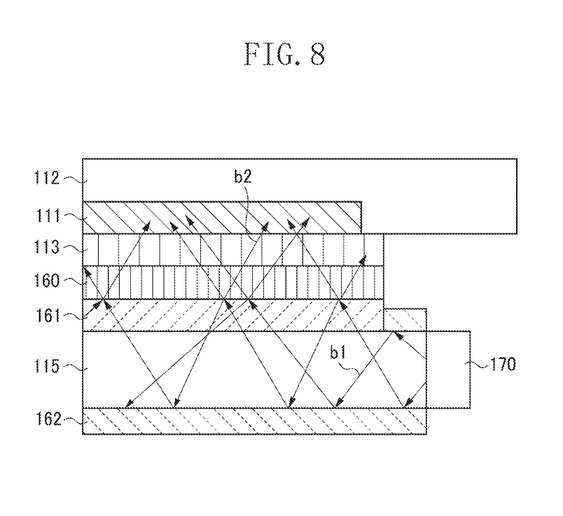

FIG. 8 is another enlarged sectional view illustrating an exemplary configuration of the radiographic apparatus according to the second exemplary embodiment of the present invention and illustrates a state in which second light from the light generator 170 is incident in the configuration illustrated in FIG. 6. The second light emitted from the light generator 170 enters the light guide plate 115 and is repeatedly reflected by the light reflection layer 162, the light diffusion layer 161, and the light reflection/transmission layer 160. Then, the second light spreads within the light guide plate 115 (indicated by b1 in FIG. 8), and the second light according to the transmittance of the light reflection/transmission layer 160 enters the photoelectric conversion unit 111 (indicated by b2 in FIG. 8). By irradiating the photoelectric conversion unit 111 with the second light from the light generator 170 through the light guide plate 115 prior to irradiating with X-rays, residual charges in the pixels 110 can be reset. Thus, the performance of the pixels 110 can be improved, and in particular, transmission efficiency of a signal charge with a low signal value can be improved.

In addition, the light amount of the light generator 170 is set such that the photoelectric conversion elements of the entire pixels 110 of the photoelectric conversion unit 111 saturate. Therefore, the light generator 170 is desirably a high-output light source such as a light emitting diode (LED), a cold-cathode tube, and a semiconductor laser. If an LED is used for the light generator 170, when the LED is not emitting light, the LED may be made to serve as the photodetector 116 as well by applying a reverse bias relative to a bias of the time when the LED is emitting light. The light generator 170 is desirably arranged on a side face of the light guide plate 115 and may be arranged on any one of a side face on which the photodetector 116 is arranged, a side face opposed to the side face on which the photodetector 116 is arranged, and a side face perpendicular to the side face on which the photodetector 116 is arranged.

Subsequently, a method for controlling the radiographic apparatus by the control unit 150 will be described. The control of the radiographic apparatus by the control unit 150 in the second exemplary embodiment differs from that in the first exemplary embodiment in that light reset processing is additionally carried out through the light generator 170 emitting light. The rest of the processes is the same as the processes in the first exemplary embodiment, and thus the description thereof will be omitted. The light reset processing is desirably carried out after the radiographic apparatus is started and specifically prior to the standby processing and after the read processing. Alternatively, if the light reset processing is carried out during the standby processing, a wavelength filter or a polarization plate is desirably used to prevent the light emitted from the light generator 170 from being detected by the photodetector 116.

As described thus far, according to the second exemplary embodiment, in addition to the effects obtained in the first exemplary embodiment, by resetting the residual charges by the light generator 170, transmission efficiency of a signal charge with a low signal value, in particular, can be improved, and thus image quality can be improved.

A third exemplary embodiment will now be described.

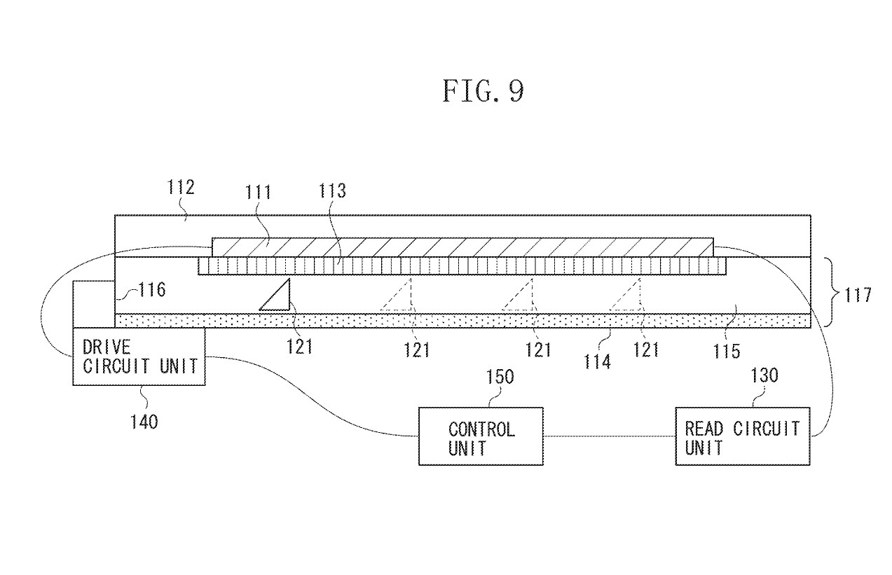

The configuration of a radiographic apparatus according to the third exemplary embodiment is similar to the configuration of the radiographic apparatus of the first exemplary embodiment illustrated in FIG. 1. FIG. 9 is a sectional view schematically illustrating an exemplary configuration of the radiographic apparatus according to the third exemplary embodiment. In FIG. 9, components that are identical to those illustrated in FIG. 1 are given identical reference numerals. The configuration illustrated in FIG. 9 differs from that illustrated in FIG. 1 in terms of the structure of the light detection unit 115 of the light guide plate 117 and the arrangement and connection of the photodetector 116 and the drive circuit unit 140. A recess is formed in the light guide plate 115 to have the scintillator 113 embedded therein, and the recess is arranged on the side of the scintillator 113 of the photoelectric conversion unit 111.

This configuration allows the scintillator 113 to be embedded in the light guide plate 115 and part of the light guide plate 115 to make contact with the photoelectric conversion unit 111. Here, as described in the first exemplary embodiment, when radiation enters the radiographic apparatus through the substrate 112, part of the radiation is absorbed by the substrate 112, and thus the amount of the X-rays to enter the scintillator 113 decreases. Therefore, if a material that absorbs the radiation to a certain degree such as glass is to be used to form the substrate 112, for example, the material needs to be formed or processed into a thin substrate. A thinly formed glass substrate has less physical strength and may break due to impact caused when moving the radiographic apparatus or a stress caused while the radiographic apparatus is installed under a patient.

In the third exemplary embodiment, the scintillator 113 is embedded into the light guide plate 115 of the light detection unit 117, and part of the light guide plate 115 of the light detection unit 117 and the substrate 112 are mutually in contact with each other. Thus, the light guide plate 115 serves as a supporting base plate for the substrate 112, which prevents the photoelectric conversion unit 111 from being damaged. The light guide plate 115 and the substrate 112 are desirably in contact with each other at a face uniformly provided to surround the scintillator 113. The light guide plate 115 and the substrate 112 may not be in contact with each other at a location where a wiring connected to the photoelectric conversion unit 111 runs. In addition to the light guide plate 115, a support base plate formed of aluminum, magnesium, carbon, or the like may additionally be used.

The photodetector 116 is provided on a side face of the light guide plate 115 in a state in which the photodetector 116 is mounted on the drive circuit unit 140. Mounting the photodetector 116 on the drive circuit unit 140 allows a wiring connecting the photodetector 116 to the control unit 150 to be commonly used to connect the drive circuit unit 140 to the control unit 150, and thus the entire system can be reduced in size. A component on which the photodetector 116 is mounted is not limited to the drive circuit unit 140, and the photodetector 116 may be mounted on one or each of the read circuit unit 130 and the control unit 150, which may then be arranged on a side face of the light guide plate 115. Similarly, the light generator 170 of the second exemplary embodiment may be mounted on the drive circuit unit 140, the read circuit unit 130, or the control unit 150, which may then be arranged on a side face of the light guide plate 115.

Similarly to the first exemplary embodiment, the photodetector 116 is arranged on a side face of the light guide plate 115, and an irradiation path of the light according to the X-rays leading to the photodetector 116 is the same as that in the first exemplary embodiment. Thus, the description thereof will be omitted. In addition, the method for controlling the radiographic apparatus by the control unit 150 is the same as that in the first exemplary embodiment, and thus the description thereof will be omitted.

A fourth exemplary embodiment will now be described.

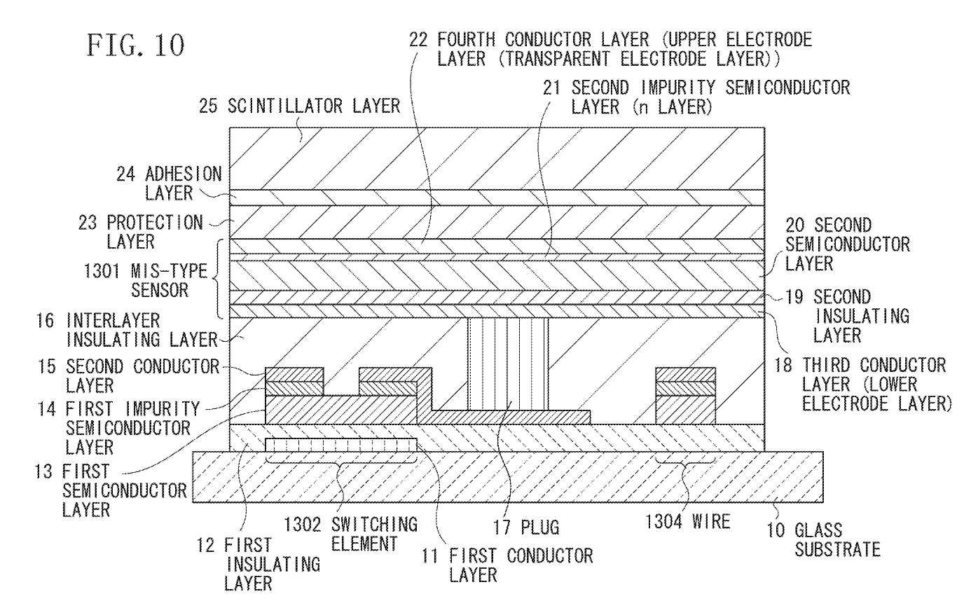

The configuration of a radiographic apparatus according to the fourth exemplary embodiment is similar to the configuration of the radiographic apparatus of the first exemplary embodiment illustrated in FIG. 1. FIG. 10 is a sectional view illustrating an exemplary configuration of one of the pixels 110 included in the photoelectric conversion unit 111 according to the fourth exemplary embodiment. The pixel 110 included in the photoelectric conversion unit 111 includes a switching element 1302 formed on a glass substrate 10 serving as an insulating substrate, and the switching element 1302 includes a first conductor layer 11, a first insulating layer 12, a first semiconductor layer 13, a first impurity semiconductor layer 14, and a second conductor layer 15 that are sequentially stacked on the glass substrate 10. Here, the switching element 1302 corresponds to any one of the switching elements T11 to T63 illustrated in FIG. 4. In the switching element 1302, the first conductor layer 11 corresponds to a gate electrode, and the second conductor layer 15 corresponds to a source electrode or a drain electrode. The first semiconductor layer 13 is formed primarily of any one of thin film semiconductor materials such as amorphous silicon, polycrystalline silicon, and an organic semiconductor.

After forming an interlayer insulating layer 16 on the second conductor layer 15, a contact hole is formed in a predetermined region of the interlayer insulating layer 16 to expose the second conductor layer 15, and then a plug 17 for plugging the contact hole, for example, is formed. Thereafter, an MIS-type sensor 1301 corresponding to any one of the photoelectric conversion elements S11 to S63 illustrated in FIG. 4 is formed on the interlayer insulating layer 16 and the plug 17. The details of the process will be described, hereinafter.

First, a third conductor layer 18, a second insulating layer 19, a second semiconductor layer 20, a second impurity semiconductor layer 21, and a fourth conductor layer 22 are sequentially stacked on the interlayer insulating layer 16 and the plug 17. The third conductor layer 18, the second insulating layer 19, the second semiconductor layer 20, the second impurity semiconductor layer 21, and the fourth conductor layer 22 stacked on the interlayer insulating layer 16 and the plug collectively constitute the MIS-type sensor 1301 corresponding to any one of the photoelectric conversion elements S11 to S63. Here, the third conductor layer 18 corresponds to a lower electrode layer of the MIS-type sensor 1301. The fourth conductor layer 22 corresponds to an upper electrode layer of the MIS-type sensor 1301 and, for example, is formed as a transparent electrode layer. The second impurity semiconductor layer 21, for example, is formed of an n-type impurity semiconductor layer.

Thereafter, a protection layer 23, an adhesion layer 24, and a scintillator layer 25 are sequentially stacked on the fourth conductor layer 22.

As illustrated in FIG. 10, the pixel 110 included in the photoelectric conversion unit 111 includes the switching element 1302 arranged on the glass substrate 10 serving as an insulating substrate and the MIS-type sensor 1301 arranged above the switching element 1302.

Such a configuration is desirable in terms of securing an aperture ratio, that is, an area of an imaging region of the photoelectric conversion unit 111.

In the example illustrated in FIG. 10, the scintillator 25 is arranged above the MIS-type sensor 1301 with the protection layer 23 and the adhesion layer 24 provided therebetween. Here, the scintillator 25 corresponding to the scintillator 113, for example, is formed primarily of a gadolinium system material or cesium iodide (CsI).

In the example illustrated in FIG. 10, X-rays that have passed through a subject are converted into first light by the scintillator 25, and the first light then enters the MIS-type sensor 1301. The MIS-type sensor 1301 subjects the first light to photoelectric conversion through the second semiconductor layer 20 to generate an electric charge. Then, an electrical signal that is based on the electric charge generated in the MIS-type sensor 1301 is sequentially transferred to the read circuit unit 130 by the switching element 1302 and read out by the read circuit unit 130. The photoelectric conversion element is not limited to the MIS-type sensor 1301, and a pn-type or PIN-type photodiode may, for example, be used instead.

The photoelectric conversion unit 111 of the fourth exemplary embodiment is fabricated through a fabrication process similar to that of a liquid crystal display. In the fabrication process of the liquid crystal display, a glass substrate having a thickness of approximately 0.5 mm to 1.0 mm is typically used. After the photoelectric conversion unit 111 is formed using such a glass substrate, the glass substrate is desirably processed to have a thickness of 0.2 mm or less through mechanical polishing or chemical polishing with absorption of the X-rays taken into consideration.

A fifth exemplary embodiment will now be described.

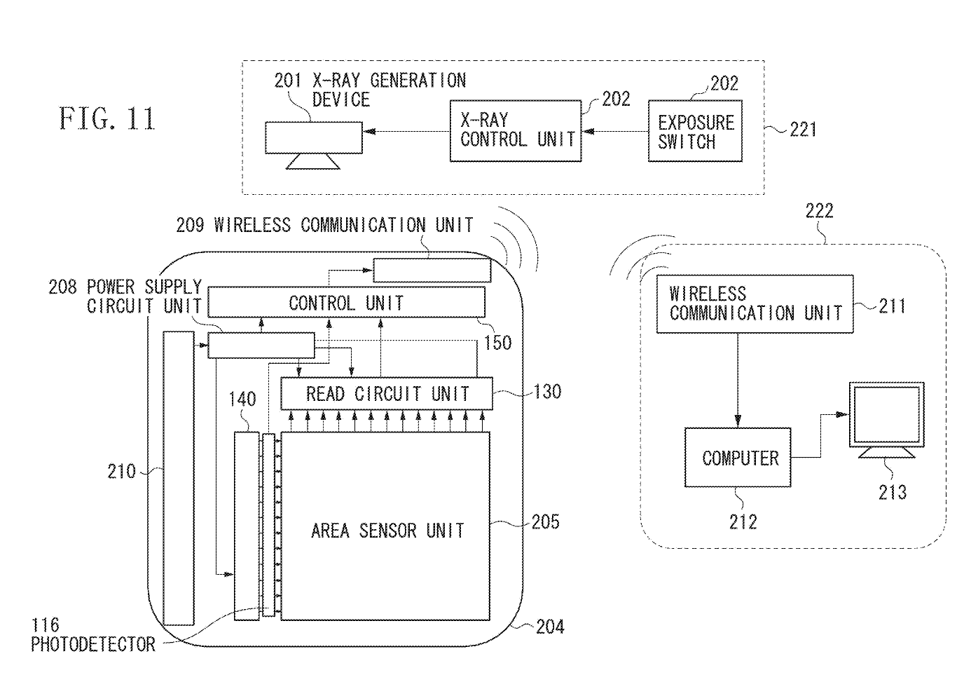

FIG. 11 schematically illustrates an exemplary configuration of a radiographic system according to the fifth exemplary embodiment. Here, an X-ray imaging system in which X-rays are used as the radiation will be described. The X-ray imaging system of the fifth exemplary embodiment includes an X-ray generation system 221, a radiographic apparatus 204, and a control system 222. The X-ray generation system 221 includes an X-ray generation device (X-ray tube) 201, an X-ray control unit 202 that controls the X-ray generation device 201, and an exposure switch 203 for turning on/off an X-ray exposure. Upon the exposure switch 203 being pressed, the X-ray generation device (radiation generation device) 201 irradiates the radiographic apparatus 204 with X-rays (radiation) through a subject according to a pre-set X-ray irradiation condition.

Any one of the radiographic apparatuses of the first to fourth exemplary embodiments may be used as the radiographic apparatus 204, and the radiographic apparatus 204 includes an area sensor unit 205, the photodetector 116, the drive circuit unit 140, the read circuit unit 130, the control unit 150, a power supply circuit unit 208, a wireless communication unit 209, and an acceleration sensor 210. The area sensor unit 205 includes the photoelectric conversion unit 111 and the light detection unit 117. The wireless communication unit 209 communicates wirelessly with a wireless communication unit 211 of the control system 222. The acceleration sensor 210 obtains positional information of the radiographic apparatus 204. The size of the radiographic apparatus 204 is similar to that of a film cassette, and thus an existing device can be embedded without making a modification thereto. In addition, the radiographic apparatus 204 weighs approximately 3 kg and thus can be carried into a hospital or the like with ease.

The control system 222 includes the wireless communication unit 211 that communicates with the radiographic apparatus 204, a computer 212, and a display 213. The computer 212 is equipped with a function of controlling the radiographic apparatus 204 through communications, a function of receiving or transmitting information necessary for imaging by connecting to a network within a hospital, and a function of controlling and displaying a graphical user interface (GUI) displayed on the display 213. In addition, the computer 212 is equipped with an image processing function of carrying out appropriate image processing on an image signal transmitted from the radiographic apparatus 204. These functions may be implemented by software or by hardware using a dedicated integrated circuit (IC) or a programmable IC.

In the configuration described above, when the exposure switch 203 is pressed and the X-rays are emitted, the X-rays that has passed through the subject reaches the radiographic apparatus 204. The radiographic apparatus 204 detects a change in a sensor bias current and causes the area sensor unit 205 to carry out an accumulation operation to convert the X-rays that have passed through the subject into electrical signals and accumulate the electrical signals. In addition, when the radiographic apparatus 204 detects that the irradiation of the X-rays is complete, the read circuit unit 130 reads out the electrical signals accumulated in the pixels, and the wireless communication unit 209 transmits digitized X-ray image signals to the computer 212. The computer 212 subjects the X-ray image signals to appropriate image processing and displays an X-ray image on the display 213.

Here, a grid may be used to obtain an X-ray image, or the radiographic apparatus 204 may be used while being inserted into a Bucky table or a lying position stand. Further, a battery charger may additionally be provided, and a plurality of the computer 212 may be provided. The control system 222 may be constituted by a mobile personal computer that can be carried. Furthermore, the computer 212 and the radiographic apparatus 204 may be connected through a cable if sufficient wireless communication is not available. In addition, a plurality of the control system 222 may be provided for a single radiographic apparatus 204, or a single control system 222 may be provided for a plurality of the radiographic apparatuses 204.

The radiographic apparatus and the radiographic system of the first to fifth exemplary embodiments can be used in medical diagnosis or industrial non-destructive testing. The radiographic apparatus and the radiographic system can be driven in synchronization with an X-ray generation device by detecting an X-ray irradiation signal or X-ray irradiation from the X-ray generation device. In the present specification, the radiation includes not only α-rays, β-rays, and γ-rays that are beams formed of particles (including photons) emitted through radioactive decay but also beams of an approximately identical level of energy, such as X-rays, corpuscular rays, and cosmic rays.

The exemplary embodiments described above merely illustrate specific examples for implementing the present invention and the technical scope of the present invention is not to be restrictively considered by the exemplary embodiments. That is, the present invention can also be implemented in various other forms without departing from the technical spirit or the principal features of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-177444 filed Aug. 9, 2012, which is hereby incorporated by reference herein in its entirety.

What is claimed is:

1. A radiographic apparatus comprising:
a scintillator configured to convert radiation into first light;
a photoelectric conversion unit including a plurality of photoelectric conversion elements each configured to convert the first light into an electrical signal; and
a light detection unit configured to detect the first light,
wherein the photoelectric conversion unit and the light detection unit are arranged to sandwich the scintillator therebetween, and
wherein the light detection unit includes a light guide plate, a photodetector arranged on a side face of the light guide plate, and a light reflection section arranged to reflect the first light in the direction of the photodetector.

2. The radiographic apparatus according to claim 1, wherein the scintillator is configured to convert the radiation that has passed through the photoelectric conversion unit into the first light.

3. The radiographic apparatus according to claim 1, wherein the scintillator is configured to convert the radiation that has passed through the light detection unit into the first light.

4. The radiographic apparatus according to claim 1, wherein the light detection unit further includes a light absorption layer, and
wherein the light absorption layer and the scintillator are arranged to sandwich the light guide plate therebetween.

5. The radiographic apparatus according to claim 1, wherein the light detection unit further includes a light reflection/transmission layer, a light diffusion layer, and a light reflection layer, and
wherein the light reflection/transmission layer, the light diffusion layer, the light guide plate, and the light reflection layer are arranged in the order of distance from the scintillator.

6. The radiographic apparatus according to claim 5, further comprising a light generator configured to irradiate through the light guide plate the photoelectric conversion unit with second light different from the first light.

7. The radiographic apparatus according to claim 6, wherein the light generator is a light emitting diode, and
wherein the light emitting diode functions as the photodetector by having a reverse bias relative to a bias at light emission being applied thereto.

8. The radiographic apparatus according to claim 1, further comprising a control unit configured to carry out standby processing of waiting for irradiation of the radiation, accumulation processing of accumulating, if the light detection unit detects a start of the irradiation of the first light, electric charges generated by the photoelectric conversion elements, and read processing of reading, if the light detection unit detects an end of the irradiation of the first light, the electrical signals from the photoelectric conversion elements to obtain a radiation image.

9. The radiographic apparatus according to claim 8, further comprising:
a drive circuit unit configured to drive the photoelectric conversion unit; and
a read circuit unit configured to read the electrical signals from the photoelectric conversion unit,
wherein the control unit is configured to control the drive circuit unit and the read circuit unit, and
wherein the photodetector of the light detection unit is mounted on the drive circuit unit, the read circuit unit, or the control unit.

10. The radiographic apparatus according to claim 1, wherein the scintillator is embedded in the light detection unit, and
wherein the light detection unit and the photoelectric conversion unit are in contact with each other.

11. A radiographic system comprising:
the radiographic apparatus according to claim 1; and
a computer configured to carry out appropriate image processing on an image signal transmitted from the radiographic apparatus.
